(19) United States
(12) Patent Application Publication
(10) Pub. No.: US 2011/0318144 A1
(43) Pub. Date: Dec. 29, 2011

(54) SUBSTRATE TRANSFER SYSTEM AND METHOD, AND COMPONENT MOUNTING APPARATUS AND METHOD

(76) Inventors: Sakae Kobayashi, Osaka (JP); Akira Kabeshita, Yamanashi (JP); Masaya Watanabe, Yamanashi (JP)

(21) Appl. No.: 13/255,378

(22) PCT Filed: Mar. 10, 2010
(86) PCT No.: PCT/JP2010/001705

§ 371 Date: Sep. 8, 2011

(30) Foreign Application Priority Data
Mar. 11, 2009 (JP) 2009-058025

(51) Int. Cl. B65G 49/06

(52) U.S. Cl. 414/222.01; 414/806

(57) ABSTRACT

A substrate transfer device has an arm, and a support shaft fixed to one end of the arm so as to pivotably support the arm in a horizontal plane. The support shaft is placed between a first working device and a second working device. A holding unit that is supported by the other end of the arm and sucks and holds an upper surface of a substrate, a rotational driving device makes the holding unit pivot on the support shaft as a center of rotation, and a posture holding mechanism keeps the pivoting holding unit in a fixed posture in horizontal directions. The substrate is transferred while the fixed posture in the horizontal directions is maintained by pivotal movement of the holding unit, between the first working device and the second working device.

### TECHNICAL FIELD

The present invention relates to a substrate transfer system and a substrate transfer method for transferring substrates for a plurality of working devices that perform specified processes for the substrates, and relates to a component mounting apparatus and a component mounting method for mounting components on component mounting regions on substrates having the component mounting regions on end parts (edge parts) thereof, in particular, on display panels represented by liquid crystal panels, plasma display panels, organic electroluminescence panels, and the like, for instance.

### BACKGROUND ART

Conventionally, display devices have been produced by mounting of components such as electronic components, mechanical components, and optical components, substrates such as flexible printed circuit boards (FPC boards), semiconductor package components such as COG (Chip On Glass), IC chips, COF (Chip On Film), and TCP (Tape Carrier Package) and/or the like on substrates (which will be referred to as “panel substrates”) such as liquid crystal display (LCD) panels and plasma display panels (PDP).

FIG. 14 shows a configuration of a conventional component mounting line for such a panel substrate (e.g., liquid crystal display substrate) 1. As shown in FIG. 14, the component mounting line 500 includes an ACF applying device 510 for performing an ACF applying step of applying anisotropic conductive film (ACF) sheets 3 on terminal parts (component mounting regions) 2 formed on edge parts (end parts) on two sides of the panel substrate 1, a component temporary press-bonding device 520 for performing a component temporary press-bonding step of temporarily press-bonding components 4 such as TCP through medium of the ACF sheets onto the terminal parts 2 with alignment thereof, a long-side main press-bonding device 530 for performing a long-side main press-bonding step of performing main press-bonding and fixing of the components 4, temporarily press-bonded onto the long-side terminal parts 2, through medium of the ACF sheets 3 while pressing and heating the components 4, a short-side main press-bonding device 540 for performing a short-side main press-bonding step of performing main press-bonding and fixing of the components 4 temporarily press-bonded onto the short-side terminal parts 2, and a substrate transfer device 550 for holding the panel substrate 1 from a lower face side thereof by conveyor arms 551 and sequentially transferring the panel substrate 1 so that the panel substrate 1 can be worked in each of the devices. In the conventional component mounting line 500 having such a configuration, the panel substrate 1 is subjected to the specified steps in the devices while being sequentially transferred in a panel substrate transfer direction D by the substrate transfer device 550, so that the components 4 are mounted on the terminal parts 2 of the panel substrate 1 (see Patent Literature 1, for instance).

In each of the devices that perform the steps, more specifically, a panel stage 512, 522, 532, 542 is provided on which the panel substrate 1 is to be placed and which holds a placement position thereof. The panel substrate 1 is delivered between adjoining panel stages by respective conveyor arms 551 the substrate transfer device 550 has. In the component mounting line 500, the devices 510, 520, 530, and 540 are arranged in a line in order of mention, and a series of conveyor lines through which the panel substrate 1 is sequentially transferred is formed. In the component mounting line 500, device component members such as heads that perform specified processes (e.g., the ACF applying step and the like) for the panel substrate 1 in the devices 510 and the like are placed on one end side E1 along the conveyor lines, and the substrate transfer device 550 is placed on the other end side E2.

FIG. 15 shows a configuration of another conventional component mounting line 600. As shown in FIG. 15, the component mounting line 600 has the same configuration as the component mounting line 500 shown in FIG. 14 has, in that an ACF applying device 610, a component temporary press-bonding device 620, a long-side main press-bonding device 630, and a short-side main press-bonding device 640 are provided and in that conveyor lines on which specified processes are sequentially performed for a panel substrate 1 are formed, but is different therefrom in configuration of substrate transfer devices. Specifically, slide transfer devices 650 for slide conveyance of the panel from one panel stage to the other panel stage are provided between panel stages 612, 622, 632, and 642 provided in the devices 610, 620, 630, and 640. Each slide transfer device 650 conveys the panel substrate 1 received from the one panel stage while holding the panel substrate at both ends thereof, and conveys the panel substrate 1 onto the other panel stage.
Patent Literature 1: Japanese Patent Application Publication No. 2001-228452

### SUMMARY OF INVENTION

### Problems to be Solved by the Invention

In recent years, there has been remarkable increase in size of displays, and use of displays having sizes not less than 30 inches, e.g., sizes of 40-inch, 50-inch, or 60-inch class has been prevailing. Accordingly, such component mounting lines are required to support component mounting for panel substrates increased in size.

When an error, trouble or the like occurs in conveyance of the panel substrate 1 in the component mounting line 500 of FIG. 14, an operator performs operations such as access from the end E2 side, manual removal of the panel substrate 1, and identification of problematic spots. For the end E2 where the substrate transfer device 550 is placed, however, it cannot be said that operability in the manual removal of the panel substrate 1 is satisfactory. Such operability is further deteriorated because the panel substrate 1 has a large size.

In the component mounting line 600 of FIG. 15, the slide transfer devices 650 provided between the devices 610, 620, 630, and 640 increase a total length of the component mounting line 600. In particular, use of the panel substrate 1 of large size causes increase in size of the slide transfer devices 650 themselves and results in further remarkable increase in size of the component mounting line 600 in a transfer direction in which the panel substrate 1 is transferred.

Therefore, it is an object of the invention to resolve problems described above and to provide a substrate transfer system and method that allow improvement in operability for an operator in maintenance or the like and reduction in a total length of devices on condition that substrates increased in size are used in substrate conveyance in which the substrates are transferred for the plurality of working devices that perform specified processes for the substrates, and to provide a component mounting apparatus and method in which the substrate conveyance is used.

### Means to Solving the Problem

In order to achieve the object, the invention is configured as follows.

According to a first aspect of the present invention, there is provided a substrate transfer system comprising:

first and second working devices that each include a substrate stage for releasably sucking and holding a lower surface of a substrate and a processing unit for performing a process for the substrate held on the substrate stage, the first and second working devices being placed so as to adjoin each other, and

a substrate transfer device including an arm, a support shaft fixed to one end of the arm so as to pivotably support the arm in a horizontal plane, the support shaft being placed between the first and second working devices, a holding unit that is supported by the other end of the arm and that releasably sucks and holds an upper surface of the substrate, a rotational driving device that makes the holding unit pivot on the support shaft as a rotation center, and a posture holding mechanism that keeps the holding unit in a fixed posture in horizontal directions during pivoting the holding unit, wherein

the rotational driving device of the substrate transfer device performs pivotal movement of the holding unit between a first transfer position that is a position on the substrate stage of the first working device and a second transfer position that is a position on the substrate stage of the second working device and thereby transfers the substrate from the substrate stage of the first working device to the substrate stage of the second working device while keeping the substrate in a fixed posture in the horizontal directions.

According to a second aspect of the present invention, there is provided the substrate transfer system according to the first aspect, wherein

the processing units are placed so as to adjoin each other in one-end regions of the first and second working devices in a transfer direction of the substrate, and

the support shaft of the substrate transfer device is placed between the processing units.

According to a third aspect of the present invention, there is provided the substrate transfer system according to the first aspect, wherein

each of the substrate stages comprises:
a substrate placement unit for releasably sucking and holding the lower surface of the substrate,
an up-and-down device for moving up and down the substrate placement unit, and
a horizontal direction moving device for moving the substrate placement unit in a horizontal direction, wherein

the horizontal direction moving device is capable of positioning the substrate placement unit in the transfer position, and

the up-and-down device is capable of positioning the substrate placement unit at a transfer height in the transfer position.

According to a fourth aspect of the present invention, there is provided the substrate transfer system according to the first aspect, wherein the posture holding mechanism of the substrate transfer device is a parallel link mechanism including a first link that is the arm and a second link that is placed in parallel with the first link and that is made to pivot while being kept in parallel relation with the first link by pivoting the arm.

According to a fifth aspect of the present invention, there is provided the substrate transfer system according to the first aspect, wherein

the holding unit of the substrate transfer device comprises:
a plurality of suction holding members for sucking and holding the upper surface of the substrate,
a plurality of drop prevention engagement members that are actuated between an engaged position in which end parts of the substrate are held and a release position in which hold of the end parts is released, and
engagement member actuating means for actuating the drop prevention engagement members from the release position to the engaged position at least in an event of abnormality in an operation of transferring the substrate in the substrate transfer device.

According to a sixth aspect of the present invention, there is provided the substrate transfer system according to the first aspect, wherein

the substrate transfer device further comprises an adjustment mechanism that adjusts the posture of the holding unit in the horizontal directions so as to correspond to the posture in the horizontal directions of the substrate positioned in the first transfer position in the first working device, and

the substrate is transferred from the first transfer position to the second transfer position, in a state in which the posture of the substrate in the horizontal directions is maintained, by pivoting the holding unit of which the posture in the horizontal directions has been adjusted by the adjustment mechanism in accordance with the posture in the horizontal directions of the substrate positioned in the first transfer position in the first working device.

According to a seventh aspect of the present invention, there is provided a component mounting apparatus in the substrate transfer system according to any one of the first through sixth aspects, wherein

the working devices are devices that perform processes for component mounting by the processing units for component mounting regions placed on end parts of the substrate, and

the processes for component mounting are sequentially performed for the component mounting regions on the substrate with transferring the substrate from the first working device to the second working device by the substrate transfer device.

According to an eighth aspect of the present invention, there is provided a substrate transfer method for transferring a substrate between first and second working devices that each include a substrate stage for releasably sucking and holding a lower surface of the substrate and a processing unit for performing a process for the substrate held on the substrate stage, the first and second working devices being placed so as to adjoin each other, the method comprising:

with using a substrate transfer device comprising an arm, a support shaft fixed to one end of the arm so as to pivotably support the arm in a horizontal plane, the support shaft being placed between the first and second working devices, and a holding unit that is supported by the other end of the arm and that releasably sucks and holds an upper surface of the substrate, delivering the substrate from the substrate stage to the holding unit by sucking and holding by the holding unit the upper surface of the substrate sucked and held on the substrate stage and by releasing sucking and holding by the substrate stage in a first transfer position that is a position on the substrate stage of the first working device,

pivoting the arm on the support shaft as a center of rotation, thereby making the holding unit pivot to a second transfer position that is a position on the substrate stage of the second working device, in a state in which a posture of the substrate in horizontal directions is maintained and

delivering the substrate from the holding unit to the substrate stage by sucking and holding the substrate by the substrate stage and by releasing sucking and holding by the holding unit in the second transfer position, thereby transferring the substrate.

The substrate may be delivered from the substrate stage to the holding unit in the first transfer position in the first working device at the transfer height position of the substrate transfer device, the holding unit may be made to pivot and move by pivoting of the arm in the state in which the transfer height position is maintained, and the substrate may be delivered from the holding unit to the substrate stage in the second transfer position in the second working device at the transfer height position of the substrate transfer device.

According to a ninth aspect of the present invention, there is provided the substrate transfer method according to the eighth aspect, wherein delivery of the substrate between the substrate stages and the holding unit in the first and second transfer positions is performed in a state in which the substrate stage has been moved up and positioned at a transfer height position in the transfer position after the holding unit is positioned in the transfer position by pivoting the arm.

According to a tenth aspect of the present invention, there is provided a component mounting method using the substrate transfer method according to the eighth or ninth aspect, comprising:

using a rectangular display panel as the substrate, the rectangular display panel having component mounting regions on a short-side terminal part and a long-side terminal part;

performing a process for component mounting for the component mounting regions on the long-side terminal part by the processing unit after positioning between the processing unit and the component mounting regions on the long-side terminal part of the substrate in the first working device;

performing a process for component mounting for the component mounting regions on the short-side terminal part by the processing unit after positioning between the processing unit and the component mounting regions on the short-side terminal part of the substrate by rotating the substrate stage;

transferring the substrate from the first transfer position to the second transfer position, in the state in which the posture of the substrate in the horizontal directions that has been subjected to the process for the component mounting regions on the short-side terminal part is maintained; and

then performing a process for component mounting for the component mounting regions on the short-side terminal part by the processing unit prior to a process for component mounting for the component mounting regions on the long-side terminal part in the second working device.

### Effect of the Invention

In the invention, the holding unit can be made to pivot and move by pivoting of the arm on the support shaft, as a center of rotation, placed between the first and second working devices, thus the holding unit sucking and holding the upper surface of the substrate delivered from the substrate stage of the first working device that is positioned in the first transfer position in the first working device can be moved to the second transfer position in the second working device, and the substrate can be transferred to the substrate stage of the second working device. By the pivoting on the one end of the arm as the center of rotation, namely, the holding unit supported by the other end of the arm can be made to pivot and moved, and the substrate can be transferred from the first transfer position to the second transfer position. Therefore, the configuration of the substrate transfer device can be simplified and the space for installation of the substrate transfer device can be made small. Accordingly, a space for maintenance in the conveyance can be ensured and operability for an operator in maintenance or the like can be improved even on condition that such large substrates as are represented, e.g., by large display panels are transferred as the substrates.

In the substrate transfer device, the support shaft thereof is provided between the working devices, and thus the space for installation thereof can be made small. This reduces distances between the working devices and reduces an apparatus length of the component mounting apparatus that employs the substrate transfer system.

### BRIEF DESCRIPTION OF DRAWINGS

These aspects and features of the invention will be apparent from the following description concerning a preferred embodiment with reference to the accompanying drawings, in which:

FIG. 1A is a schematic view of a panel substrate in a state prior to performance of an ACF applying step in a component mounting line in accordance with an embodiment of the invention;

FIG. 1B is a schematic view of the panel substrate in a state posterior to the performance of the ACF applying step in the component mounting line of the embodiment;

FIG. 1C is a schematic view of the panel substrate in a state posterior to performance of a component temporary press-bonding step in the component mounting line of the embodiment;

FIG. 1D is a schematic view of the panel substrate in a state posterior to performance of a long-side main press-bonding step in the component mounting line of the embodiment;

FIG. 1E is a schematic view of the panel substrate in a state posterior to performance of a short-side main press-bonding step in the component mounting line of the embodiment;

FIG. 2 is a schematic view of the component mounting line of the embodiment;

FIG. 3 is a schematic view of a substrate transfer device included in the component mounting line of FIG. 2;

FIG. 4 is a schematic view of a pivotal motion (pivoting path) of the substrate transfer device of FIG. 3;

FIG. 5 is a schematic view of actuation of drop prevention holding claws included in the substrate transfer device of FIG. 2;

FIG. 6A is a schematic plan view of a component temporary press-bonding device and a long-side main press-bonding device;

FIG. 6B is a schematic front view of the component temporary press-bonding device and the long-side main press-bonding device;

FIG. 7A is a schematic plan view illustrating procedures of transfer the panel substrate between the component temporary press-bonding device and the long-side main press-bonding device;

FIG. 7B is a schematic front view illustrating the procedures of transfer the panel substrate between the component temporary press-bonding device and the long-side main press-bonding device;

FIG. 8A is a schematic plan view illustrating the procedures of transfer the panel substrate between the component temporary press-bonding device and the long-side main press-bonding device;

FIG. 8B is a schematic front view illustrating the procedures of transfer the panel substrate between the component temporary press-bonding device and the long-side main press-bonding device;

FIG. 9A is a schematic plan view illustrating the procedures of transfer the panel substrate between the component temporary press-bonding device and the long-side main press-bonding device;

FIG. 9B is a schematic front view illustrating the procedures of transfer the panel substrate between the component temporary press-bonding device and the long-side main press-bonding device;

FIG. 10A is a schematic plan view illustrating the procedures of transfer the panel substrate between the component temporary press-bonding device and the long-side main press-bonding device;

FIG. 10B is a schematic front view illustrating the procedures of transfer the panel substrate between the component temporary press-bonding device and the long-side main press-bonding device;

FIG. 11 is a schematic view of a substrate transfer device in accordance with a modification of the embodiment;

FIG. 12A is a schematic view of a state in which the panel substrate is held by the substrate transfer device of FIG. 11;

FIG. 12B is a schematic view of a state in which the panel substrate (turned 90 degrees) is held by the substrate transfer device of FIG. 11;

FIG. 13 is a schematic view of a component mounting method using the substrate transfer device of the modification of FIG. 11;

FIG. 14 is a schematic view of a conventional component mounting line; and

FIG. 15 is a schematic view of another conventional component mounting line.

### DESCRIPTION OF EMBODIMENTS

Prior to continuation of description of the invention, the same components through the accompanying drawings are designated by the same reference characters.

Hereinbelow, an embodiment of the invention will be described in detail with reference to the drawings.

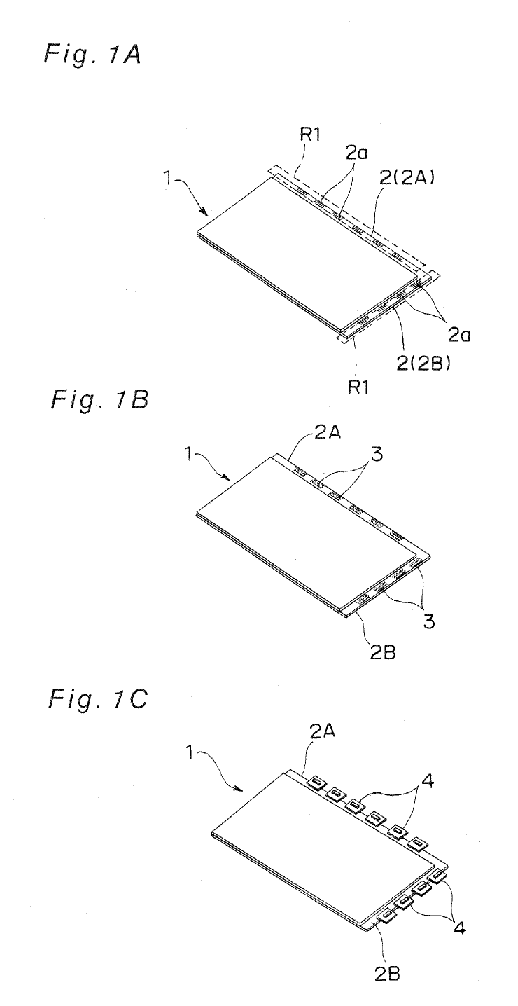

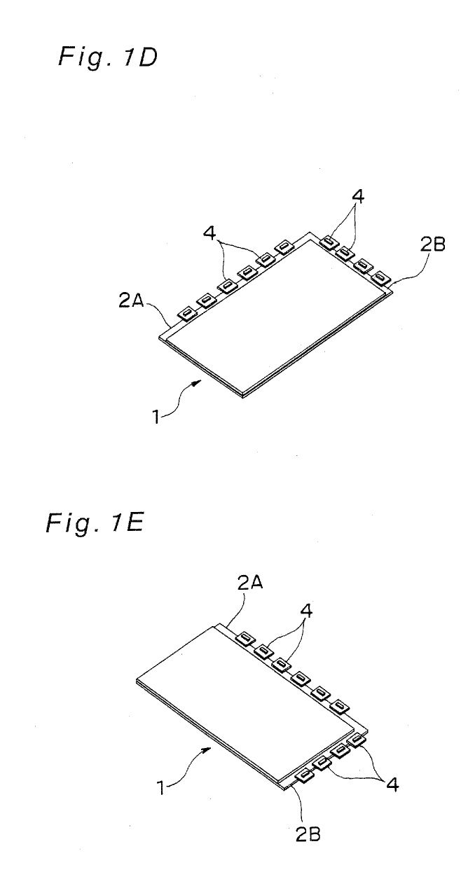

For description on a substrate transfer system, a substrate transfer method, a component mounting apparatus, and a component mounting method in accordance with one embodiment of the invention, initially, a form of a panel substrate 1 that is handled in the component mounting apparatus, the component mounting method and the like and a summary of mounting processes that are performed on the panel substrate 1 will be described with reference to FIGS. 1A, 1B, 1C, 1D, and 1E.

As shown in FIG. 1A, a substrate that is handled in the embodiment is a substrate (which will be referred to as “panel substrate”) 1 typified by liquid crystal display (LCD) panel substrate, plasma display panel (PDP) substrate and the like, and the substrate has terminal parts 2, provided with component mounting regions R1 to be mounted with components, on edge parts (end parts) on adjoining two sides of a rectangular shape thereof. The panel substrate 1 commonly has the rectangular shape, and the terminal parts 2 are formed as a long-side terminal part (a terminal part shown on deep side in FIG. 1A) 2A and as a short-side terminal part (a terminal part shown on front side in FIG. 1A) 2B. A plurality of terminal electrodes 2a are formed on each of the terminal parts 2, and the components are mounted on and electrically connected to the terminal electrodes 2a. A region of the panel substrate 1 that is inside the edge parts is a display region on which images such as pictures and character information are displayed. The panel substrate 1 is chiefly formed of glass material, and a thickness of such a substrate has been decreased so as to be not larger than 0.5 mm, for instance. The panel substrate 1 that is handled in the embodiment is a panel substrate that is particularly increased in size and that may be used for a display having a size not less than 30 inches, e.g., of 40 inches, 50-inch class, or 60-inch class, for instance.

In the component mounting method of the embodiment, for the panel substrate 1 having such a structure, ACF sheets 3 as joining members are pasted on the terminal electrodes 2a of the terminal parts 2 in an ACF applying step (see FIGS. 1A and 1B), thereafter TCPs 4, for instance, as the components are temporarily press-bonded with alignment (positioning) onto the terminal electrodes 2a through the ACFs 3 in a component temporary press-bonding step (see FIGS. 1B and 1C), the TCPs 4 temporarily press-bonded on the long-side terminal part 2A are thereafter pressed and mounted on the long-side terminal part 2A in a long-side component main press-bonding step (see FIG. 1C), the TCPs 4 temporarily press-bonded on the short-side terminal part 2B are pressed and mounted on the short-side terminal part 2B in a short-side component main press-bonding step (see FIG. 1D), and the TCPs 4 are thus mounted on the panel substrate 1, as shown in FIG. 1E, by performance of the steps. Such steps are referred to as outer lead bonding steps, for instance.

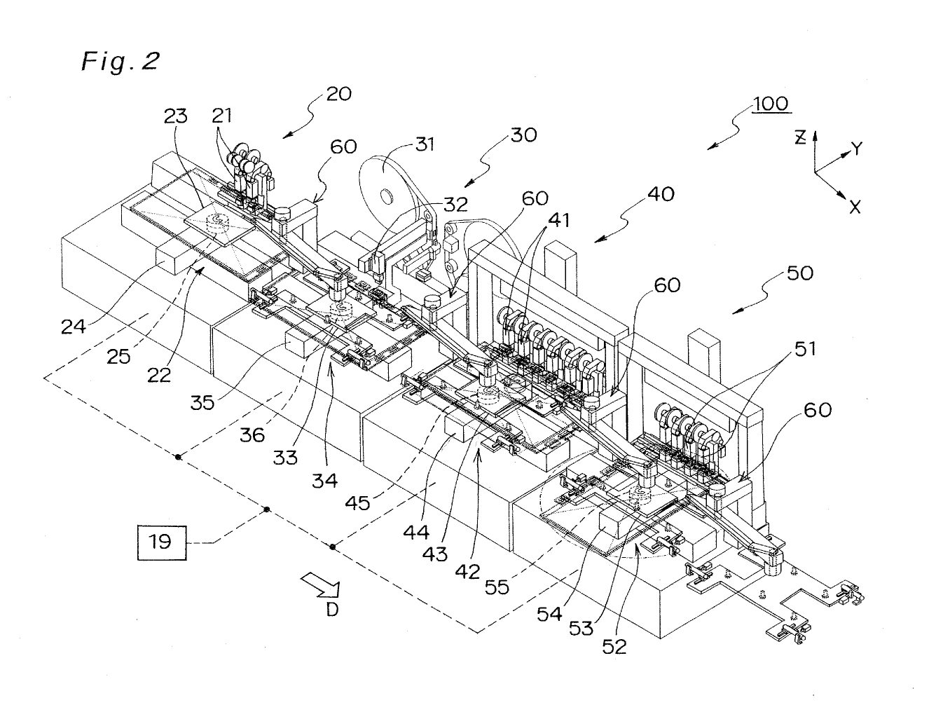

Subsequently, FIG. 2 shows a schematic perspective view showing a configuration of a component mounting line 100 that is an example of the component mounting apparatus for performing such a component mounting method (that is, outer lead bonding steps).

As shown in FIG. 2, the component mounting line 100 includes an ACF applying device 20 for performing the ACF applying step for the panel substrate 1, a component temporary press-bonding device 30 for performing the component temporary press-bonding step for the components such as the TCPs 4 on the panel substrate 1 pasted with the ACF sheets 3, a long-side main press-bonding device 40 for performing the long-side main press-bonding step of performing main press-bonding and mounting of the TCPs 4 temporarily press-bonded on the long-side terminal part 2A of the panel substrate 1, and a short-side main press-bonding device 50 for performing the short-side main press-bonding step of performing main press-bonding and mounting of the TCPs 4 temporarily press-bonded onto the short-side terminal parts 2B of the panel substrate 1. Between the devices 20, 30, 40 and 50 are provided substrate transfer devices 60 for performing delivery and reception (transfer) of the panel substrate 1 therebetween. The long-side main press-bonding device 40 and the short-side main press-bonding device 50 are provided as separate devices in the component mounting line 100 shown in FIG. 2, whereas the main press-bonding steps may be performed, in the component mounting line, by one main press-bonding device that carries out switching between the long side and the short side of the panel substrate, depending upon required tact. The devices 20, 30, 40 and 50 in the embodiment are an example of the working devices (first working device and second working device), and the steps as the processes are performed for the panel substrate 1. In the component mounting line 100, a transfer line (transfer direction) for the panel substrate 1 is formed so as to extend from the ACF applying device 20 toward the short-side main press-bonding device 50.

The ACF applying device 20 has press-bonding units 21 for cutting the tape-like ACF sheet 3, forwarded from a tape feeding part to a tape recovery part, into pieces with a specified length and applying the ACFs on the terminal parts 2 of the panel substrate 1, and a panel stage (substrate stage) 22 that has a substrate placement unit 23 on which the panel substrate 1 carried into the ACF applying device 20 is placed and which releasably sucks and holds the placed panel substrate 1 and that performs positioning between the terminal parts 2 of the panel substrate 1 placed on the substrate placement unit 23 and the press-bonding units 21. The panel stage 22 has an XYθ moving device 24 having a function (XY moving function) of moving the placed panel substrate 1 in an X-axis direction or a Y-axis direction shown in the drawing and a function (θ rotating function) of rotating the panel substrate 1 in a plane including the X-axis direction and the Y-axis direction, and an up-and-down device 25 having a function (moving-up-down function) of moving up and down the panel substrate 1 in a Z-axis direction, and the functions make it possible to attain positioning of the long-side terminal part 2A and the short-side terminal part 2B of the panel substrate 1 with respect to the press-bonding units 21. In FIG. 2, the X-axis direction and the Y-axis direction are directions generally extending along a surface of the panel substrate 1, a transfer direction D for the panel substrate 1 is the X-axis direction, a direction orthogonal to the X-axis direction is the Y-axis direction, and a vertical direction shown in the drawing is the Z-axis direction.

The component temporary press-bonding device 30 has a TCP feeding cassette part 31 for feeding a plurality of TCPs 4 contained in cassettes, a temporary-press-bonding head 32 for temporarily press-bonding the TCPs 4, fed from the TCP feeding cassette part 31, through medium of the ACF sheets 3 onto the terminal electrodes 2a with alignment thereof, and a panel stage 34 that has a substrate placement unit 33 on which the panel substrate 1 is to be placed and which releasably sucks and holds the placed panel substrate 1 and that performs positioning between the terminal parts 2 of the panel substrate 1 placed on the substrate placement unit 33 and the temporary-press-bonding head 32. The panel stage 34 has an XYθ moving device 35 having the XY moving function and the θ rotating function, and an up-and-down device 36 having the moving-up-down function.

The long-side main press-bonding device 40 has a plurality of thermal press-boding units 41 that include thermal press-bonding heads as an example of mounting heads for heating while pressing the TCPs 4 temporarily press-bonded through the ACF sheets 3 on the long-side terminal part 2A of the panel substrate 1 and thereby attaining main press-bonding, i.e., thermal press-bonding (mounting) of the TCPs 4 through the ACF sheets 3 onto the respective terminal electrodes 2a and include backup tools for supporting the terminal parts 2 of the panel substrate 1 from a lower surface side thereof in main press-bonding operations, and a panel stage 42 for performing positioning between the thermal press-boding units 41 and the long-side terminal part 2A of the panel substrate 1. The panel stage 42 has a substrate placement unit 43 on which the panel substrate 1 is to be placed and which releasably sucks and holds the placed panel substrate 1, an XYθ moving device 44 having the XY moving function and the θ rotating function relative to the substrate placement unit 43, and an up-and-down device 45 having the moving-up-down function.

The short-side main press-bonding device 50 has a plurality of thermal press-boding units 51 that include thermal press-bonding heads for heating while pressing the TCPs 4 temporarily press-bonded through the ACF sheets 3 on the short-side terminal part 2B of the panel substrate 1 and thereby attaining main press-bonding of the TCPs 4 through the ACF sheets 3 onto the respective terminal electrodes 2a and include backup tools for supporting the terminal parts 2 of the panel substrate 1 from the lower surface side thereof in the main press-bonding operations, and a panel stage 52 for performing positioning between the thermal press-boding units 51 and the short-side terminal parts 2B of the panel substrate 1. The panel stage 52 has a substrate placement unit 53 on which the panel substrate 1 is to be placed and which releasably sucks and holds the placed panel substrate 1, an XYθ moving device 54 having the XY moving function and the θ rotating function relative to the substrate placement unit 53, and an up-and-down device 55 having the moving-up-down function.

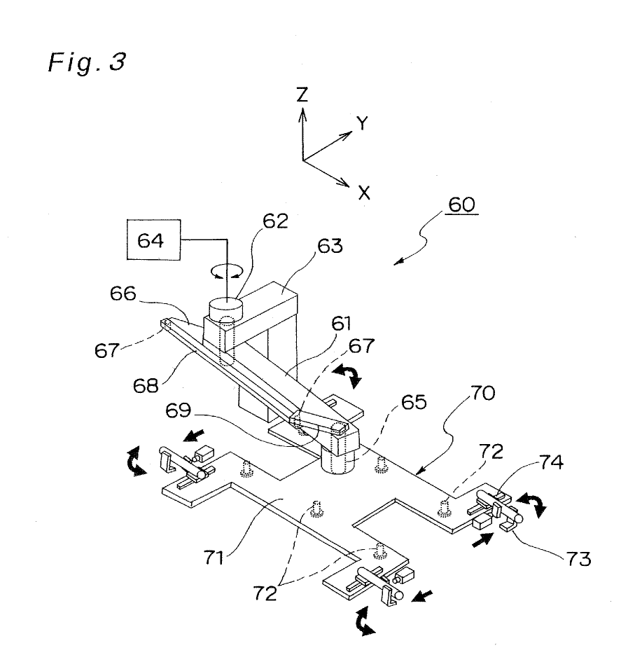

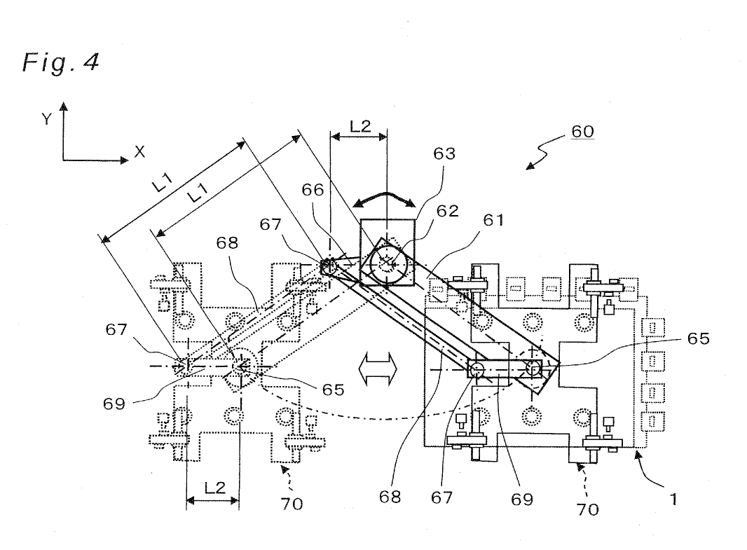

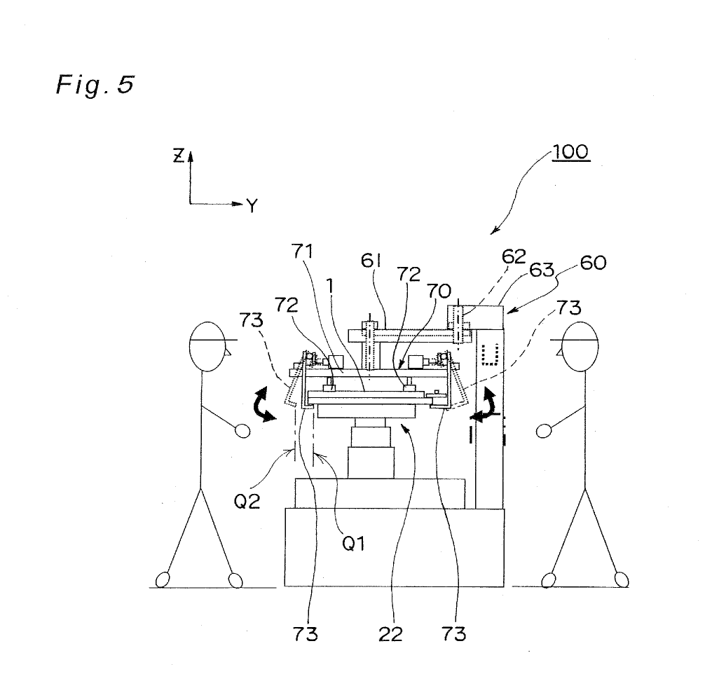

Subsequently, a configuration of the substrate transfer devices 60 the component mounting line 100 includes will be described in detail. For the description, FIG. 3 shows a schematic perspective view of the substrate transfer device 60, and FIG. 4 shows a schematic plan view showing status of the device in operation.

As shown in FIG. 3, the substrate transfer device 60 has an arm 61, a support shaft 62 for supporting one end of the arm 61 so that the arm 61 is pivotable in the horizontal plane (XY plane), and a holding unit 70 that is supported by the other end of the arm 61 and that releasably sucks and holds an upper surface of the panel substrate 1. The support shaft 62 is placed above a device base in a state in which the support shaft 62 is fixed through a frame 63 to the device base, and the arm 61 is pivotable on an axis of the support shaft 62 as a center of rotation. The substrate transfer device 60 has a rotational driving device 64 for making the arm 61 pivot (or swing) within a specified angle range on the support shaft 62 as the center of rotation. By pivoting of the arm 61 by the rotational driving device 64, the holding unit 70 supported by the other end of the arm 61 can be made to pivot and moved.

As shown in FIG. 3, the holding unit 70 has a plate member 71 supported by the arm 61 at a center position thereof and a plurality of suction holding parts 72 that are provided on a lower surface of the plate member 71 and that suck and hold the upper surface of the panel substrate 1. The suction holding parts 72 are placed symmetrically and evenly with respect to the center position of the plate member 71 and are connected to vacuum lines not shown.

The substrate transfer device 60 has a posture holding mechanism for keeping a posture of the holding unit 70 in horizontal directions (i.e., posture in the XY plane) so as not to prevent the posture from being changed by pivotal movement of the holding unit 70 on occasion when the pivotal movement is made by the pivoting of the arm 61 as described above. As such a posture holding mechanism, specifically, as shown in FIGS. 3 and 4, there is provided a parallel link mechanism including the arm 61, as a first link, and a link member 68, as a second link, that is placed in parallel with the first link and that is made to pivot while being kept in parallel with the first link on occasion when the pivotal movement of the arm 61 is made.

In the parallel link mechanism which will be described further in detail, as shown in FIGS. 3 and 4, the one end of the arm 61 is fixed to the support shaft 62 so as to allow the pivoting on the support shaft 62 as the center of rotation by rotating of the support shaft 62. The plate member 71 is supported by the other end of the arm 61 through a joint 65 (movable part) that is rotatable relative to the arm 61 and is fixed to the joint 65. A link member 66 that is engaged with the support shaft 62 so as to be pivotable relative to the support shaft 62 is fixed to the frame 63 and is placed along the X-axis direction shown in the drawing. That is, the link member 66 that is fixed to the frame 63 regardless of the rotation or pivoting of the support shaft 62 and the arm member is engaged with the support shaft 62. One end part of the link member 68 is engaged with one end part of the link member 66 through a joint 67 that is a movable part, and the link member 68 has the same length L1 as the arm 61 has and is placed in parallel with the arm 61. One end part of a link member 69 that has a length as large as a link length L2 of the link member 66 engaged with the support shaft 62 and the link member 68 is engaged with the other end part of the link member 68 through another joint 67, and the other end part of the link member 69 is fixed to the joint 65 and is engaged with the other end of the arm 61 through the joint 65. That is, the arm 61 and the link member 68 placed in parallel therewith are connected through the link members 66 and 69 parallel to each other, and the link member 66 is fixed in the position along the X-axis direction, so that a state in which the link members 66, 68, 69 and the arm 61 form a parallelogram configured with the link lengths L1, L2 is maintained regardless of pivotal position of the arm 61, and so that the link member 69 is made to extend along the X-axis direction at all times. As shown in FIG. 4, accordingly, the plate member 71 that is in a fixed relation to the link member 69 and the joint 65 is held in a fixed posture (orientation) without being rotated even when the arm 61 is made to pivot. In an example shown in FIGS. 3 and 4, a second link is composed of the link members 66, 68, 69 and the joints 65, 67.

As shown in FIG. 3, the holding unit 70 holds the panel substrate 1 by sucking and holding the upper surface of the panel substrate 1 by the plurality of suction holding parts 72, and further has a plurality of drop prevention holding claws (drop prevention holding members) 73 for mechanically holding the panel substrate 1 so as to prevent dropping of the panel substrate 1 that is being held, in such an abnormal event as occurrence of conveyance error (e.g., decrease in vacuum pressures for sucking and holding the panel substrate 1). The holding claws 73 are provided so as to be pivotable between a holding position Q1 and a hold release position Q2, are normally kept in the hold release position (or stand-by position) as shown in FIG. 5, and are made to pivot to the holding position in the event of abnormality by actuating means (engagement member actuating means) not shown so that the panel substrate 1 is held. By the provision of the drop prevention holding claws 73, the panel substrate 1 can be prevented from dropping in the event of occurrence of abnormality such as decrease in the vacuum pressures and power outage even on condition that the large and expensive panel substrate 1 is transferred with suction and holding of the upper surface thereof. Each of the drop prevention holding claws 73 is provided with a slide mechanism 74 for slide adjustment of a mounting position thereof on the plate member 71 so as to support holding of the panel substrate 1 having various sizes. As an example of the actuating means, for instance, various means that are applied to fail safe designs for various devices may be employed.

In the component mounting line 100 is provided a control device 19 for generally controlling operations of the devices 20, 30, 40, 50 and 60 while relating the control to mutual operations. Conveyance of the panel substrate 1 from the devices on upstream side toward the devices on downstream side is sequentially controlled, while the operations of the devices are individually controlled, by the control device 19, and thus component mounting operations for a plurality of panel substrates 1 are performed. The control device 19 may have a configuration of a control mode as one integrated control device. Alternatively, a control mode may be used which is individually provided in each of the devices and in which conveyance control signals for the panel substrate 1 are transmitted between the devices.

Subsequently, component mounting operations in the component mounting line 100 having such a configuration will be described. The operations that will be described below are performed while being controlled by the control device 19.

In the component mounting line 100 of FIG. 2, the panel substrate 1 shown in FIG. 1A is carried in and placed on the panel stage 22 of the ACF applying device 20, and the lower surface of the panel substrate 1 is sucked and held by the panel stage 22.

Subsequently, XY movement of the panel substrate 1 held by the panel stage 22 is performed by the XYθ shifting device 24, and up-and-down movement thereof is performed by the up-and-down device 25, so that positioning between the long-side terminal part 2A of the panel substrate 1 and the press-bonding units 21 is attained. After that, the press-bonding units 21 are lowered and the ACF sheets 3 are pasted on the long-side terminal part 2A (ACF applying step). Subsequently, θ rotating by the panel stage 22 and positioning between the short-side terminal part 2B and the press-bonding units 21 are performed, and the ACF sheets 3 are pasted on the short-side terminal part 2B by the press-bonding units 21. Upon completion of the ACF applying step, the long-side terminal part 2A of the panel substrate 1 is positioned so as to extend along the X-axis direction by θ rotating by the panel stage 22. After that, the holding unit 70 of the substrate transfer device 60 sucks and holds the upper surface of the panel substrate 1, the suction and holding by the panel stage 22 is released, and the panel substrate 1 is delivered to the substrate transfer device 60. Subsequently, the panel substrate 1 is transferred to the component temporary press-bonding device 30 by the substrate transfer device 60.

In the component temporary press-bonding device 30, the panel substrate 1 transferred by the substrate transfer device 60 is delivered by being placed on the panel stage 34. For the temporary-press-bonding head 32, a TCP 4 is fed from the TCP feeding cassette part 31, and is sucked and held by the temporary-press-bonding head 32. Subsequently, positioning between one terminal electrode 2a on the long-side terminal part 2A of the panel substrate 1 and the temporary-press-bonding head 32 sucking and holding the TCP 4 is performed by the panel stage 34, the temporary-press-bonding head 32 is thereafter lowered onto the terminal electrode 2a, and the TCP 4 is thereby temporarily press-bonded onto the terminal electrode 2a through the ACF sheet 3. With sequential repetition of similar operations, the TCPs 4 are temporarily press-bonded on the terminal electrodes 2a (component temporary press-bonding step). Upon completion of the temporary press-bonding of the TCPs 4 onto the long-side terminal part 2A, θ rotating of the panel substrate 1 is performed by the panel stage 34, positioning between the short-side terminal part 2B and the temporary-press-bonding head 32 is performed, and the temporary press-bonding of the TCPs 4 onto the terminal electrodes 2a on the short-side terminal part 2B is sequentially performed. Upon completion of the component temporary press-bonding step, the holding unit 70 of the substrate transfer device 60 sucks and holds the upper surface of the panel substrate 1, the suction and holding by the panel stage 34 is released, and the panel substrate 1 is delivered to the substrate transfer device 60. Subsequently, the panel substrate 1 is transferred to the long-side main press-bonding device 40 by the substrate transfer device 60.

In the long-side main press-bonding device 40, the panel substrate 1 transferred by the substrate transfer device 60 is delivered by being placed on the panel stage 42. Subsequently, the long-side terminal part 2A of the panel substrate 1 is placed on the backup tools of the press-boding units 41 by the panel stage 42, the thermal press-bonding heads are thereafter lowered, and the TCPs 4 temporarily applied are thereby heated while being pressed against the terminal electrodes 2a through the ACF sheets 3, so that mounting of the TCPs 4 with thermal press-bonding is attained (long-side main press-bonding step). Upon completion of the long-side main press-bonding step, the holding unit 70 of the substrate transfer device 60 sucks and holds the upper surface of the panel substrate 1, the suction and holding by the panel stage 42 is released, and the panel substrate 1 is delivered to the substrate transfer device 60. Subsequently, the panel substrate 1 is transferred to the short-side main press-bonding device 50 by the substrate transfer device 60.

In the short-side main press-bonding device 50, main press-bonding onto the short-side terminal part 2B of the panel substrate 1 is performed through procedures similar to those in the long-side main press-bonding device 40, so that the TCPs 4 are mounted on the terminal electrodes 2a through the ACF sheets 3 (short-side main press-bonding step). Upon completion of the short-side main press-bonding step, the holding unit 70 of the substrate transfer device 60 sucks and holds the upper surface of the panel substrate 1, the suction and holding by the panel stage 34 is released, and the panel substrate 1 is delivered to the substrate transfer device 60. Subsequently, the panel substrate 1 is carried out of the component mounting line 100 by the substrate transfer device 60. In the component mounting line 100, the plurality of panel substrates 1 are sequentially transferred by the substrate transfer devices 60, the specified steps are performed in the devices, and component mounting steps are attained for the panel substrates 1.

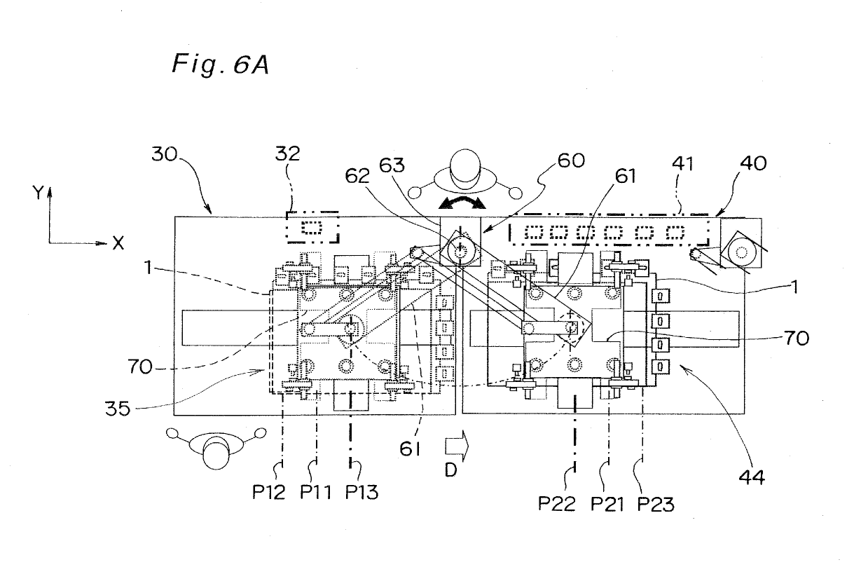

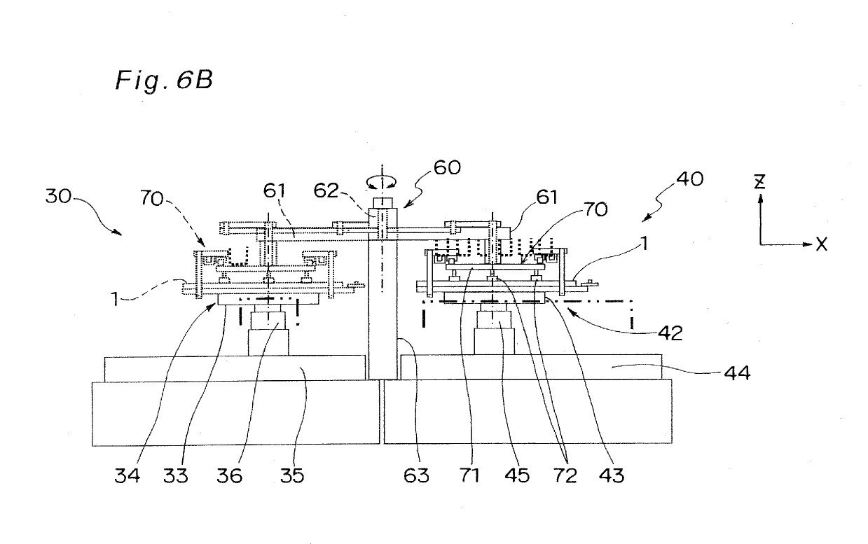

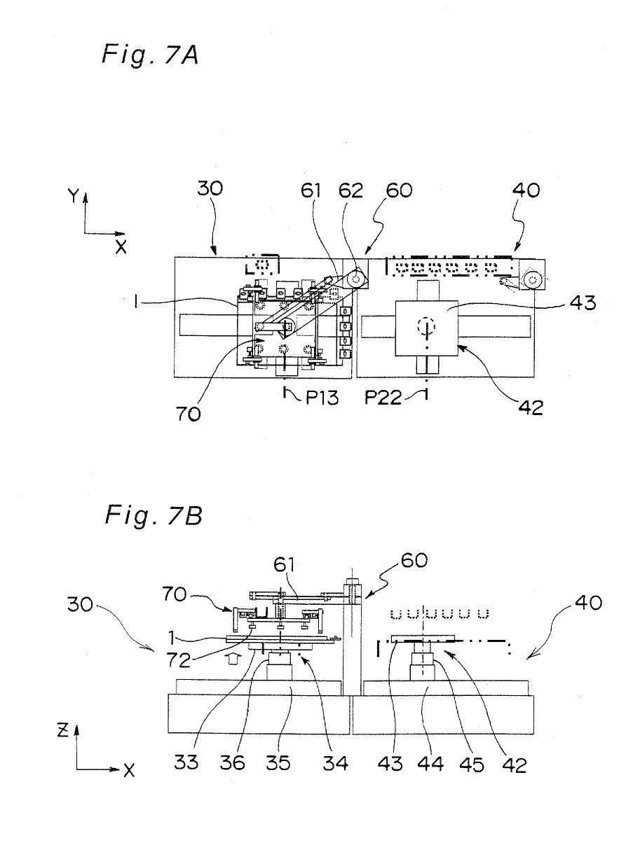

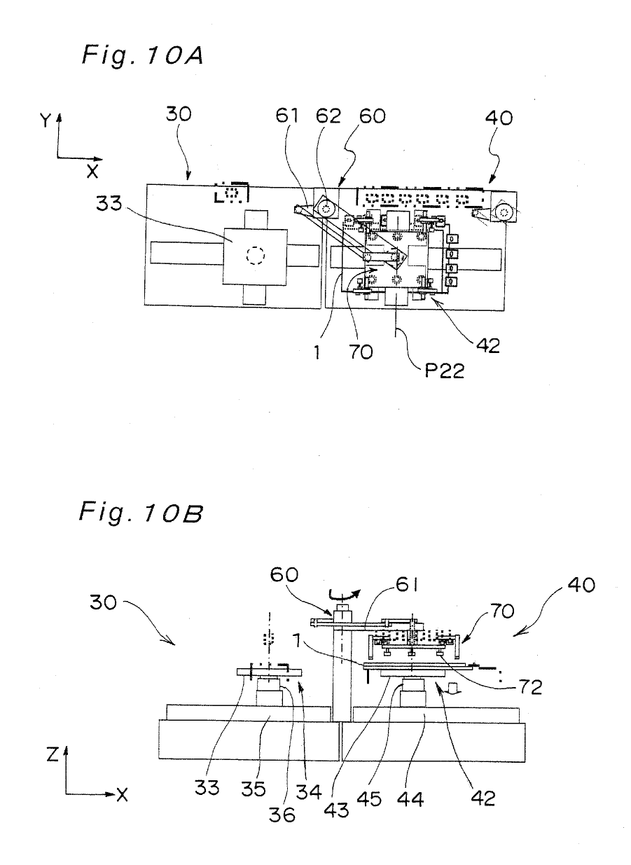

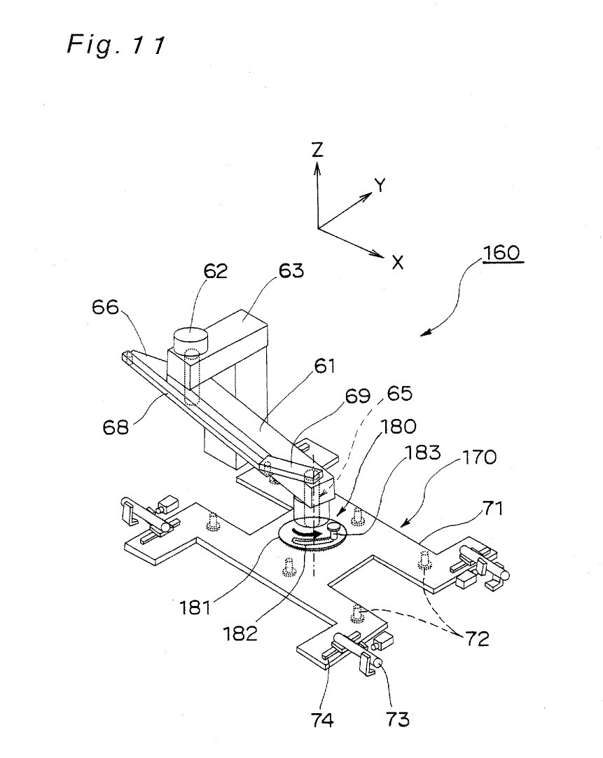

Subsequently, an operation of transferring (conveying) the panel substrate 1 by the substrate transfer devices 60 the component mounting line 100 having such a configuration includes will be described in detail. The substrate transfer devices 60 provided in the component mounting line 100 have the same configuration, and thus the substrate transfer device 60 that performs transfer (delivery and reception) of the panel substrate 1 between the component temporary press-bonding device 30 and the long-side main press-bonding device 40 will be described as a representative of the devices with reference to a schematic plan view of FIG. 6A and a schematic front view of FIG. 6B. Furthermore, procedures of transfer the panel substrate 1 from the component temporary press-bonding device 30 to the long-side main press-bonding device 40 with use of the substrate transfer device 60 will be described below with reference to schematic plan views and schematic front views shown in FIGS. 7A, 7B, 8A, 8B, 9A, 9B, 10A, and 10B.

As shown in FIGS. 6A and 6B, a frame 63 of the substrate transfer device 60 is placed in a left end region, with respect to the transfer direction (X-axis direction) for the panel substrate 1, between the component temporary press-bonding device 30 and the long-side main press-bonding device 40.

In the component temporary press-bonding device 30, the panel stage 34 can be translated by the XYθ moving device 35 at least so as to be positioned in a working position P11 that is generally a center position in a movable range thereof in the X-axis direction which is the transfer direction for the panel substrate 1, a receiving position P12 that is a position upstream of the working position P11 in the transfer direction, and a delivery position P13 (an example of the first transfer position) that is a position downstream of the working position P11 in the transfer direction. Herein, the working position P11 is a position in which the component temporary press-bonding step (process) is performed for the panel substrate 1, and the receiving position P12 (an example of the second transfer position) is a position in which the panel substrate 1 is transferred to the panel stage 34 from the substrate transfer device 60 provided between the ACF applying device 20 and the component temporary press-bonding device 30. The delivery position P13 is a position in which the panel substrate 1 is transferred from the panel stage 34 to the substrate transfer device 60 provided between the panel component temporary press-bonding device 30 and the long-side main press-bonding device 40.

In the long-side main press-bonding device 40, similarly, the panel stage 42 can be translated by the XYθ moving device 44 at least so as to be positioned in a working position P21 that is generally a center position in a movable range thereof in the X-axis direction which is the transfer direction for the panel substrate 1, a receiving position P22 that is a position upstream of the working position P21 in the transfer direction, and a delivery position P23 that is a position downstream of the working position P21 in the transfer direction. The working position P21 is a position in which the long-side main press-bonding step (process) for the panel substrate 1 is performed.

The panel stage 34, 42 can be moved up and down by the up-and-down device 36, 45, and the substrate placement unit 33, 43 can be positioned in a substrate transfer height position H1 that is a given height position when the delivery and receiving operation for the panel substrate 1 is performed between the panel stages 34, 42 and the substrate transfer device 60 in the delivery positions P13, P23 and the receiving positions P12, P22.

In the substrate transfer device 60, as shown in FIGS. 6A and 6B, the delivery position P13 and a length of the arm 61 are defined so that a holding center of the holding unit 70 can be positioned over the delivery position P13 in the component temporary press-bonding device 30 by pivoting of the arm 61. Moreover, the receiving position P22 and the length of the arm 61 are defined so that the holding center of the holding unit 70 can be positioned over the receiving position P22 in the long-side main press-bonding device 40 by pivoting of the arm 61.

Subsequently, specific procedures for transferring the panel substrate 1 by the substrate transfer device 60 will be described.

In the component temporary press-bonding device 30, as shown in FIGS. 7A and 7B, the panel substrate 1 having undergone the component temporary press-bonding step is held by the substrate placement unit 33 of the panel stage 34, with the long-side terminal part 2A thereof set in a posture along the transfer direction for the panel substrate 1, the XY movement (or X movement) thereof is effected by the XYθ moving device 35, and the panel substrate 1 is positioned in the delivery position P13. For prevention of interference between the panel substrate 1 and the holding unit 70 and the like of the substrate transfer device 60, the substrate placement unit 33 is then placed in a withdrawal height position that is below the substrate transfer height position H1. In the substrate transfer device 60, simultaneously, the arm 61 is made to pivot by rotational drive of the support shaft 62 by the rotational driving device 64 and the holding unit 70 is positioned in the delivery position P13. Once the holding unit 70 is positioned in the delivery position P13, the substrate placement unit 33 is moved up from the withdrawal height position to the substrate transfer height position H1 by the up-and-down device 36 in the panel stage 34.

In the long-side main press-bonding device 40, in parallel with these operations, the substrate placement unit 43 of the panel stage 42 holding no panel substrate 1 makes XY movement (or X movement) caused by the XYθ moving device 44 and is thereby positioned in the receiving position P22. For prevention of interference between the panel substrate 1 and the holding unit 70 and the like of the substrate transfer device 60, the substrate placement unit 43 is then placed in the withdrawal height position that is below the substrate transfer height position H1.

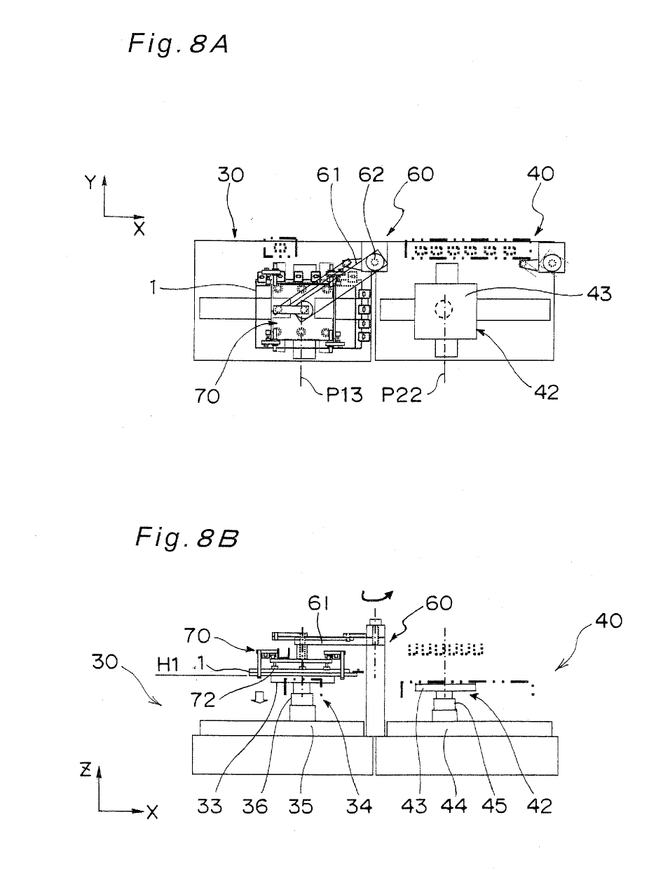

In the delivery position P13 in the component temporary press-bonding device 30, as shown in FIGS. 8A and 8B, the upper surface of the panel substrate 1 in the substrate transfer height position H1 is brought into contact with the suction holding parts 72 of the holding unit 70, vacuum pressures for sucking and holding the panel substrate 1 are applied to the suction holding parts 72, and the upper surface of the panel substrate 1 is thereby sucked and held by the holding unit 70. After that, the suction and holding of the panel substrate 1 by the substrate placement unit 33 of the panel stage 34 is released, the substrate placement unit 33 is thereafter lowered below the substrate transfer height position H1, and the panel substrate 1 is thereby delivered from the panel stage 34 to the substrate transfer device 60.

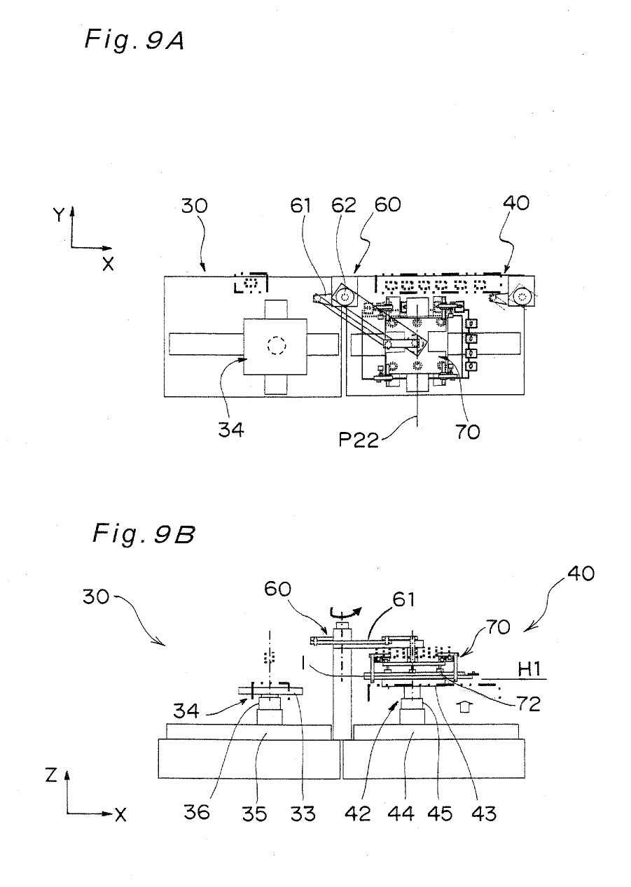

Upon the delivery of the panel substrate 1, as shown in FIGS. 9A and 9B, the arm 61 is made to pivot by rotational drive of the support shaft 62 by the rotational driving device 64, so that the holding unit 70 holding the panel substrate 1 is thereby made to pivot and is positioned in the receiving position P22 in the long-side main press-bonding device 40, while the substrate transfer height position H1 in the substrate transfer device 60 for delivering the panel substrate 1 is maintained in the substrate transfer device 60. The posture in the XY plane of the panel substrate 1 positioned in the receiving position P22 is not changed from the posture thereof in the delivery position P13 because the parallel link mechanism is employed in the substrate transfer device 60. Once the holding unit 70 is positioned in the receiving position P22, the substrate placement unit 43 is moved up from the withdrawal height position to the substrate transfer height position H1 in the panel stage 42, and the panel substrate 1 held by the holding unit 70 is placed on the substrate placement unit 43. After that, the suction and holding by the suction holding parts 72 of the holding unit 70 is released and the lower surface of the panel substrate 1 is sucked and held by the substrate placement unit 43 of the panel stage 22. The substrate placement unit 43 on which the panel substrate 1 is held is thereafter lowered from the substrate transfer height position H1 in the panel stage 43, and the panel substrate 1 is thereby delivered from the substrate transfer device 60 to the panel stage 34 at the transfer height position H1 for the substrate transfer device with the transfer height position maintained.

Through the above procedures, the panel substrate 1 is transferred from the component temporary press-bonding device 30 to the long-side main press-bonding device 40. In other substrate transfer devices 60 the component mounting line 100 includes, the panel substrate 1 is transferred through similar procedures.

The conveyance of the panel substrate that is performed by the substrate transfer device between two working devices, e.g., the component temporary press-bonding device 30 and the long-side main press-bonding device 40, which are placed so as to adjoin each other has been described as an example of the substrate transfer system for the embodiment, whereas the transfer method using the substrate transfer system can be applied to working devices as long as the working devices perform specified processes for substrates. In the embodiment, the press-bonding units 21 of the ACF applying device 20, the temporary-press-bonding head 32 of the component temporary press-bonding device 30, the thermal press-bonding units 41 of the long-side main press-bonding device 40, and the thermal press-bonding units 51 of the short-side main press-bonding device 50 make an example of processing units the working devices include.

In the component mounting line 100 of the embodiment, the holding unit 70 is made to pivot and moved by the pivoting of the arm 61 on the support shaft 62, as the center of rotation, of the substrate transfer device 60 placed between the devices that are placed adjacent to each other, and the holding unit 70 holding the upper surface of the panel substrate 1 placed on the panel stage 34, e.g., in the delivery position P13 in the component temporary press-bonding device 30 is moved to the receiving position P22 in the long-side main press-bonding device 40, for instance, so that the panel substrate 1 can be delivered, i.e., transferred to the panel stage 42.

By the pivoting on the one end of the arm 61 as the center of rotation, namely, the holding unit 70 supported by the other end of the arm 61 can be made to pivot and moved, and the panel substrate 1 can be transferred from the delivery position P13 to the receiving position P22. Therefore, a configuration of the substrate transfer device 60 can be simplified and a space for installation of the substrate transfer device 60 can be made small in comparison with conventional substrate transfer devices that convey a panel substrate while supporting the panel substrate from underside thereof by a conveyor arm. Therefore, a space for maintenance in the conveyance can be ensured and operability for an operator in maintenance or the like can be improved even on condition that such large panel substrates as are used, e.g., for large display panels are transferred as the panel substrates.

As shown in FIG. 6A, in particular, a configuration of the placement is employed in which the frame 63 of the substrate transfer device 60 is placed in the left end part of the device with respect to the transfer direction for the panel substrate 1. In the component mounting line 100 with the employment of such a configuration, a left side space of the device with respect to the transfer direction for the panel substrate 1 can be used as a space where the working units, the frame 63 of the substrate transfer device 60 and the like are placed and a right side space with respect to the transfer direction can be utilized as a maintenance space where no other devices are placed, for instance. When occurrence of abnormality or the like in conveyance of the large panel substrate 1 causes requirement of maintenance by an operator, for instance, satisfactory operability can be ensured because the maintenance space is ensured.

In the substrate transfer device 60, the frame 63 supporting the support shaft 62 is provided between the devices, and thus the space for installation thereof can be made small in comparison with conventional slide transfer devices. This reduces distances between the devices and reduces an apparatus length of the component mounting line 100 that employs the substrate transfer system.

In the substrate transfer device 60 is provided the parallel link mechanism for keeping the horizontally fixed posture of the holding unit 70 when the holding unit 70 is made to pivot and moved by the pivoting of the arm 61 in the substrate transfer device 60. Accordingly, the panel substrate 1 can be delivered in the receiving position P22 without change in the posture (posture or orientation in the XY plane) of the panel substrate 1 in the delivery position P13 for the panel substrate 1.

The delivery and reception of the panel substrate 1 between the holding unit 70 on the arm 61 in the substrate transfer device 60 and the panel stage (22, 34, 42, 52) is performed by the up-and-down operation of the panel stage (22, 34, 42, 52), the holding unit 70 is made to pivot and moved in a state in which the substrate transfer height position H1 in the substrate transfer device 60 is maintained and in which the posture of the substrate in the horizontal directions is kept, and thus the panel substrate 1 can be transferred from the delivery position P13 to the receiving position P22.

Even on condition that such a large and/or thin panel substrate as is used, e.g., for a large display panel is transferred as the panel substrate, therefore, conveyance with decrease in stresses caused by inertia of the panel substrate 1 can be attained with employment of a configuration of movement of the panel substrate 1 by the pivoting operation of the arm 61 without extra operations such as turn and up-and-down operation for the panel substrate 1 in a state in which the upper surface of the panel substrate 1 is sucked and held by the holding unit 70 of the substrate transfer device 60, and risks such as dropping of the panel can be reduced because the up-and-down operation for the panel substrate 1 is not performed in a state in which the large and/or thin panel substrate is sucked and held from a side of the upper surface thereof, in particular. The one example in which the parallel link mechanism is employed as the posture holding mechanism for the panel substrate 1 has been described in the description on the embodiment, whereas other various configurations may be employed as the posture holding mechanism. For instance, a configuration may be employed in which the holding unit 70 is made to pivot according to a quantity of pivoting of the arm 61 with use of an electric motor so that a posture of the holding unit 70 is held. The configuration of the device, however, can be simplified with use of a parallel link mechanism requiring no electrical means.

In the panel stage (e.g., the panel stage 34) provided in the devices of the component mounting line 100 are provided the XYθ moving device 35 for performing the XY movement and the θ rotating of the substrate placement unit 33 on which the panel substrate 1 is placed and held and the up-and-down device 36 for performing the up-and-down movement thereof. In the substrate transfer devices 60, therefore, the functions of the holding and pivotal movement of the panel substrate 1 are provided and it is unnecessary to provide other moving mechanisms for up-and-down movement and the like of the panel substrate 1. Accordingly, the configuration of the substrate transfer device 60 can further be simplified and the space for the installation can be made small.

The invention is not limited to the above embodiment but can be embodied in other various manners. For instance, FIG. 11 shows a schematic diagram of a substrate transfer device 160 in accordance with a modification of the embodiment.

The substrate transfer device 160 in accordance with the modification of FIG. 11 has a configuration that is different from that of the substrate transfer device 60 in that orientation of a holding unit 170 can be changed 90 degrees in an XY plane. Component members and devices of the substrate transfer device 160 that are the same as those of the substrate transfer device 60 are designated by the same reference characters, and description thereof is omitted.

In a part of a plate member 71 of the holding unit 170 that is fixed to a joint 65, as shown in FIG. 11, a position adjustment mechanism (an example of adjustment mechanism) 180 that makes it possible to change a positional relation between both is provided. The position adjustment mechanism 180 includes a disc member 181 fixed to the plate member 71 and an engagement pin 183 engaged with a groove part 182 provided along a circumferential direction on peripheral part of the disc member 181. The engagement pin 183 is relatively slidable along the groove part 182, and orientation of the plate member 71 can be changed 90 degrees by the relative slide along the groove part 182 of the engagement pin 183 positioned at one end of the groove part 182 and by positioning thereof at the other end of the groove part 182. A position of the engagement pin 183 can releasably be fixed to the positions in the groove part 182.

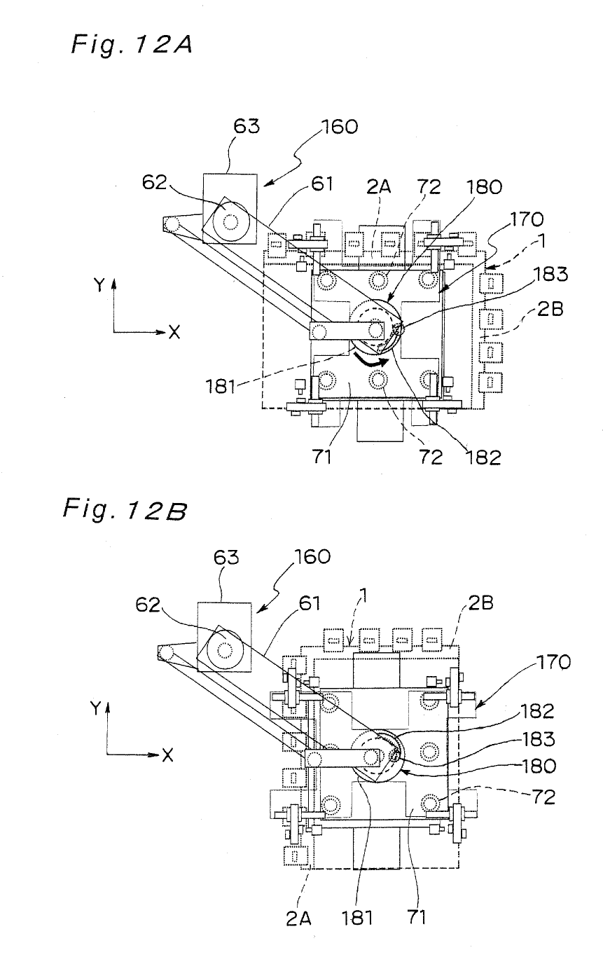

Such provision of the position adjustment mechanism 180 in the substrate transfer device 160 makes it possible to selectively attain a holding mode in which the panel substrate 1 is sucked and held by the holding unit 70 in a posture with the long-side terminal part 2A extending along the X-axis direction as shown in FIG. 12A and a holding mode in which the panel substrate 1 is sucked and held by the holding unit 70 in a posture with the short-side terminal part 2B extending along the X-axis direction as shown in FIG. 12B, for instance.

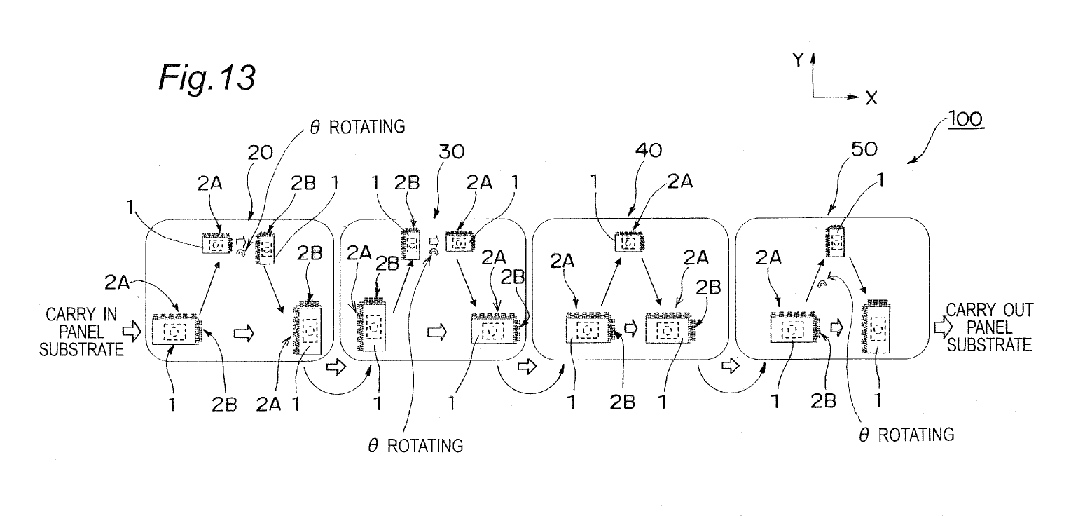

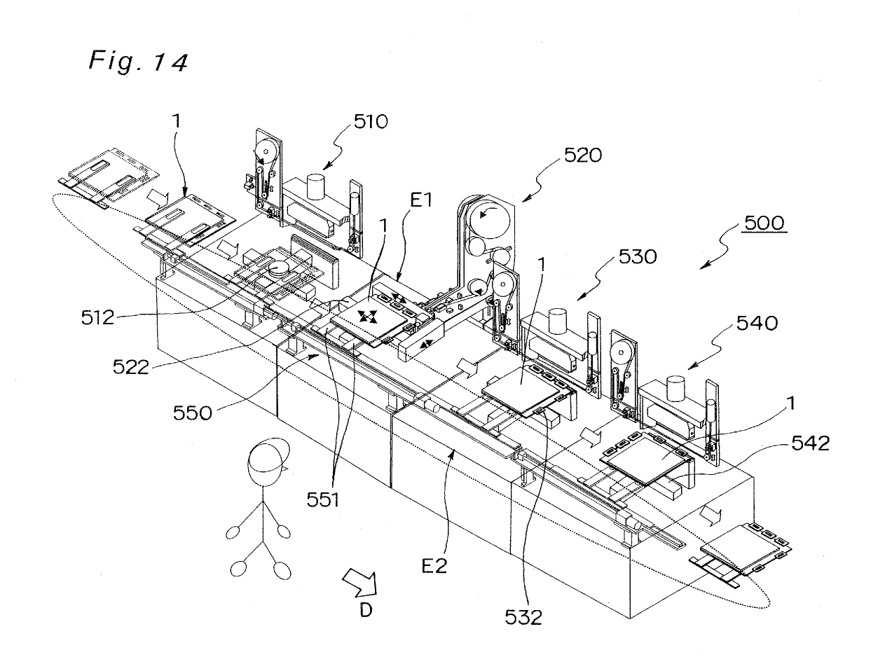

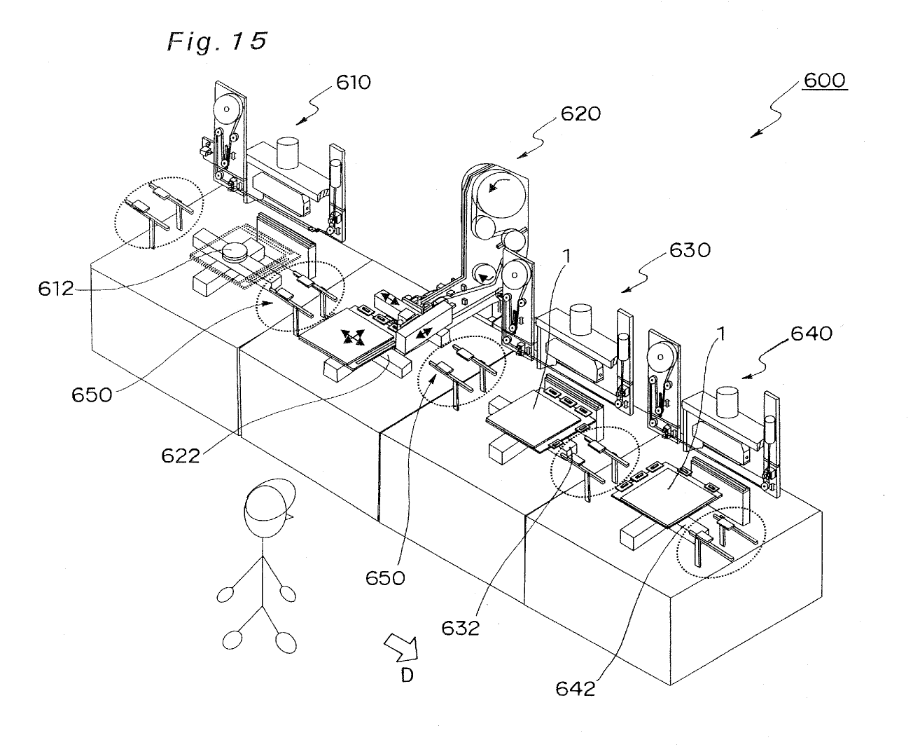

Herein, a component mounting method for the panel substrate 1 with active use of characteristics of the substrate transfer device 160 in accordance with the modification will be described with reference to a schematic illustration shown in FIG. 13.

In a component mounting line including the plurality of substrate transfer devices 160, initially, the position adjustment mechanism 180 is set so that the holding unit 70 of the substrate transfer device 160 placed between the ACF applying device 20 and the component temporary-press-bonding device 30 conveys the panel substrate 1 in the posture with the short-side terminal part 2B extending along the X-axis direction as shown in FIG. 12B, for instance.

In the ACF applying device 20 shown in FIG. 13, the panel substrate 1 with the long-side terminal part 2A placed along the X-axis direction is carried in and the ACF applying step is performed for the long-side terminal part 2A. Subsequently, the short-side terminal part 2B is placed along the X-axis direction by the θ rotating performed by the panel stage 22, and the ACF applying step is performed for the short-side terminal part 2B. After that, the panel substrate 1 is transferred to the component temporary press-bonding device 30 by the substrate transfer device 160 while being kept in the posture with the short-side terminal part 2B placed along the X-axis direction (that is, without θ rotating (90 degrees rotating) of the panel substrate 1).

In the component temporary press-bonding device 30, the panel substrate 1 carried in is subjected to the component temporary press-bonding step for the short-side terminal part 2B placed along the X-axis direction, without undergoing θ rotating (90 degrees rotating). Subsequently, the 0 rotating of the panel substrate 1 is performed by the panel stage 34, and the component temporary press-bonding step is performed for the long-side terminal part 2A placed along the X-axis direction. After that, the panel substrate 1 is transferred to the long-side main press-bonding device 40 by the substrate transfer device 160 while being kept in the posture with the long-side terminal part 2A placed along the X-axis direction.

In the long-side main press-bonding device 40, the panel substrate 1 carried in is subjected to the main press-bonding step for the long-side terminal part 2A placed along the X-axis direction, without undergoing θ rotating (90 degrees rotating). After that, the panel substrate 1 is transferred to the short-side main press-bonding device 50 by the substrate transfer device 160 and the short-side main press-bonding step is performed in the short-side main press-bonding device 50.

In the component mounting method employing such a method of transfer the panel substrate 1, a number of times of the θ rotating of the panel substrate 1 can be decreased in the devices 20, 30, 40 and 50. That is, the ACF applying step for the short-side terminal part 2B is performed in the ACF applying device 20, shown in FIG. 13, and the panel substrate 1 is thereafter transferred to the component temporary press-bonding device 30 by the substrate transfer device 160 without the θ rotating of the panel substrate 1. In the component temporary press-bonding device 30, the component temporary press-bonding step for the short-side terminal part 2B is performed for the panel substrate 1 with the short-side terminal part 2B placed along the X-axis direction, without the θ rotating thereof. At least in the ACF applying device 20 and the component temporary press-bonding device 30, therefore, the number of times of the θ rotating of the panel substrate 1 can be decreased. Accordingly, a number of times stresses caused by inertia are applied by the performance of the θ rotating of the panel substrate 1 can be decreased. For the panel substrate 1 increased in size and/or decreased in thickness, in particular, a quantity of stresses caused by the rotating thereof substantially increases in comparison that of the panel substrate 1 of a small size. Thus the stresses applied to the panel substrate can effectively be decreased by employment of the transfer method and the mounting method. Besides, the transfer method, by which tact time for component mounting can be decreased, is effective in terms of improvement in productivity.

Appropriate combinations of any desired embodiments out of the various embodiments described above are capable of achieving the effects which the combined embodiments have.

The invention has fully been described with respect to the preferred embodiments in reference to the accompanying drawings; however, various changes and modifications are apparent to those skilled in the art. It is to be understood that such changes and modifications are embraced by the scope of the invention unless departing from the scope of the invention as defined in the appended claims.

The disclosure of description, drawings, and claims of Japanese patent application No. 2009-058025 filed on Mar. 11, 2009 are incorporated herein by reference in its entirety.

1-10. (canceled)

11. A substrate transfer system comprising:
first and second working devices that each include a substrate stage for releasably sucking and holding a lower surface of a substrate and a processing unit for performing a process for the substrate held on the substrate stage, the first and second working devices being placed so as to adjoin each other, and
a substrate transfer device including an arm, a support shaft fixed to one end of the arm so as to pivotably support the arm in a horizontal plane, the support shaft being placed between the first and second working devices, a holding unit that is supported by the other end of the arm and that releasably sucks and holds an upper surface of the substrate, a rotational driving device that makes the holding unit pivot on the support shaft as a center of rotation, and a posture holding mechanism that keeps the holding unit in a fixed posture in horizontal directions during pivoting the holding unit, wherein
each of the substrate stages comprises;
a substrate placement unit for releasably sucking and holding the lower surface of the substrate,
an up-and-down device for moving up and down the substrate placement unit, and
a horizontal direction moving device for moving the substrate placement unit in a horizontal direction, wherein
the horizontal direction moving device of the first working device is capable of positioning the substrate placement unit in a first working position and a first transfer position nearer to a second working position than the first working position, and the up-and-down device of the first working device is capable of positioning the substrate placement unit at a transfer height in the first transfer position,
the horizontal direction moving device of the second working device is capable of positioning the substrate placement unit in the second working position and a second transfer position nearer to the first working position than the second working position, and the up-and-down device of the second working device is capable of positioning the substrate placement unit at a transfer height in the second transfer position, and
the rotational driving device of the substrate transfer device performs pivotal movement of the holding unit between the first transfer position and the second transfer position while maintaining the transfer height and thereby transfers the substrate from the substrate stage of the first working device to the substrate stage of the second working device while keeping the substrate in a fixed posture in the horizontal directions so as to receive the substrate from the substrate placement unit by sucking and holding the substrate at the transfer height in the first transfer position and so as to deliver the substrate to the other substrate placement unit by releasing sucking and holding at the transfer height in the second transfer position.

12. The substrate transfer system according to claim 11, wherein
the processing units are placed so as to adjoin each other in one-end regions of the first and second working devices in a transfer direction of the substrate, and
the support shaft of the substrate transfer device is placed between the processing units.

13. The substrate transfer system according to claim 11, wherein each of the up-and-down device moves up and down the substrate placement unit between the transfer height and a withdrawal height that is a height position preventing interference between the substrate placement units and the holding unit of the substrate transfer device which is positioned at the transfer height in the first and second transfer positions, the withdrawal height being placed below the transfer height in each of the substrate stages.

14. The substrate transfer system according to claim 11, wherein the posture holding mechanism of the substrate transfer device is a parallel link mechanism including a first link that is the arm and a second link that is placed in parallel with the first link and that is made to pivot while being kept in parallel relation with the first link by pivoting the arm.

15. The substrate transfer system according to claim 11, wherein
the holding unit of the substrate transfer device comprises:
a plurality of suction holding members for sucking and holding the upper surface of the substrate,
a plurality of drop prevention engagement members that are actuated between an engaged position in which end parts of the substrate are held and a release position in which hold of the end parts is released, and
engagement member actuating means for actuating the drop prevention engagement members from the release position to the engaged position at least in an event of abnormality in an operation of transferring the substrate in the substrate transfer device.

16. The substrate transfer system according to claim 11, wherein
the substrate transfer device further comprises an adjustment mechanism that adjusts the posture of the holding unit in the horizontal directions so as to correspond to the posture in the horizontal directions of the substrate positioned in the first transfer position in the first working device, and
the substrate is transferred from the first transfer position to the second transfer position, in a state in which the posture of the substrate in the horizontal directions is maintained, by pivoting the holding unit of which the posture in the horizontal directions has been adjusted by the adjustment mechanism in accordance with the posture in the horizontal directions of the substrate positioned in the first transfer position in the first working device.

17. A component mounting apparatus in the substrate transfer system according to claim 11, wherein
the working devices are devices that perform processes for component mounting by the processing units for component mounting regions placed on end parts of the substrate, and
the processes for component mounting are sequentially performed for the component mounting regions on the substrate with transferring the substrate from the first working device to the second working device by the substrate transfer device.

18. A substrate transfer method for transferring a substrate between first and second working devices that each include a substrate stage for releasably sucking and holding a lower surface of the substrate and a processing unit for performing a process for the substrate held on the substrate stage, the first and second working devices being placed so as to adjoin each other, the method comprising:
moving the substrate sucked and held on the substrate stage from a first working position to a first transfer position nearer to a second working position than the first working position in the first working device;
with using a substrate transfer device comprising an arm, a support shaft fixed to one end of the arm so as to pivotably support the arm in a horizontal plane, the support shaft being placed between the first and second working devices, and a holding unit that is supported by the other end of the arm and that releasably sucks and holds an upper surface of the substrate, pivoting the arm thereby positioning the holding unit in the first working position;
thereafter delivering the substrate from the substrate stage to the holding unit by moving up the substrate by the substrate stage so as to position the substrate at a transfer height, by sucking and holding by the holding unit the upper surface of the substrate sucked and held on the substrate stage, and by releasing sucking and holding by the substrate stage in the first transfer position;
moving the substrate stage from the second working position to a second transfer position nearer to the first working position than the second working position in the second working device;
pivoting the holding unit from the first transfer position to the second transfer position, in a state in which the transfer height and a posture of the substrate in horizontal directions are maintained, by pivoting the arm on the support shaft as a rotation center; and
thereafter delivering the substrate from the holding unit to the substrate stage by moving up the substrate stage so as to position the substrate stage at the transfer height and by sucking and holding the substrate by the substrate stage, and by releasing sucking and holding by the holding unit in the second transfer position, thereby transferring the substrate.

19. A component mounting method using the substrate transfer method according to claim 18, in which a rectangular display panel having component mounting regions on a short-side terminal part and a long-side terminal part is used as the substrate, and in which the substrate is transferred between the first working device, the second working device and a third working device with use of a first substrate transfer device that is placed between the first working device and the second working device and a second substrate transfer device that is placed between the second working device and the third working device, the substrate transfer method comprising:
a) performing a process for the component mounting regions on the long-side terminal part by a working unit in the first working device, thereafter rotating the substrate stage, and performing a process for the component mounting regions on the short-side terminal part by the working unit in the first working device;
b) transferring the substrate by the first substrate transfer device from the first transfer position to the second transfer position, in a state in which a posture thereof in the horizontal directions that has been subjected to the process for the component mounting regions on the short-side terminal part is maintained;
c) performing a process for the component mounting regions on the short-side terminal part by a working unit in the second working device, thereafter rotating the substrate stage, and performing a process for the component mounting regions on the long-side terminal part by the working unit in the second working device;
d) transferring the substrate by the second substrate transfer device from the second transfer position to the third transfer position in the third working device, in a state in which a posture thereof in the horizontal directions that has been subjected to the process for the component mounting regions on the long-side terminal part is maintained;
e) performing a process for the component mounting regions on the long-side terminal part by a working unit in the third working device; and
f) using position adjustment mechanisms for changing mounted postures of the holding units to the arms in the horizontal directions in the first and second substrate transfer devices, and setting the mounted posture of the holding unit in the first substrate transfer device and the mounted posture of the holding unit in the second substrate transfer device in advance so that the mounted postures differ by 90 degrees, before the steps a) through e) are performed.
